(19) United States
(12) Patent Application Publication
(10) Pub. No.: US 2025/0273865 A1
(43) Pub. Date: Aug. 28, 2025

(54) MAGNETO-ELECTRIC DIPOLE ANTENNA AND ANTENNA ARRAY USING THE SAME

(71) Applicant: Alpha Networks Inc., Hsinchu (TW)

(72) Inventors: Ta-Chuan BAI, Hsinchu (TW); Ding-Bing LIN, Hsinchu (TW); Sung-Nien HSIEH, Hsinchu (TW); Kun-Lin HE, Hsinchu (TW)

(21) Appl. No.: 18/810,358

(22) Filed: Aug. 20, 2024

(30) Foreign Application Priority Data
Feb. 23, 2024 (TW) 113106531

(51) Int. Cl. H01Q 9/28; H01Q 1/50; H01Q 19/00

(52) U.S. Cl. CPC H01Q 9/285; H01Q 1/50; H01Q 19/005

(57) ABSTRACT

In a magneto-electric dipole antenna, first to third substrates are stacked from top to bottom. A ground layer is disposed between the second and third substrates. Four sector patches and a first feed-out line are disposed on the first substrate. Four ground plates and first and second feed-in lines are disposed below the third substrate. Each of four vias penetrates the second and third substrates and the ground layer. A second feed-out line is disposed between the first and second substrates. Each of first and second feed-out probes penetrates the first to third substrates and the ground layer. The n^{th} feed-out probe is connected to the n^{th} feed-in line and the n^{th} feed-out line, where 1≤n≤2. When two signals are fed to the feed-in lines, the signals are transmitted to the feed-out lines through the feed-out probes, and two electromagnetic waves are radiated.

### CROSS-REFERENCE TO RELATED APPLICATION

This application claims priority to Taiwanese Patent Application No. 113106531, filed on Feb. 23, 2024, and incorporated by reference herein in its entirety.

### FIELD

The disclosure relates to antenna technology, and more particularly to a magneto-electric dipole antenna and an antenna array using the same.

### BACKGROUND

With the advancement of communication technology and integrated circuit technology, components of consumer electronic products are continuously being miniaturized. As the demand for wireless communications grows, antennas having the advantages of lower cost, smaller size and better performance are favored by consumers. Among various antenna technologies, patch antennas have the aforementioned advantages, and are widely used in various electronic products because they can be manufactured easily, can be easily integrated with circuits, and have a high degree of design diversity. In addition, with the rapid development of low-orbit satellites, the demand for antenna arrays has increased. Taiwanese Patent Application Publication No. 202335369 discloses a multi-layered magneto-electric dipole antenna that includes multiple horizontal patches, multiple vias and multiple probes. The horizontal patches are disposed on different layers of the multi-layered magneto-electric dipole antenna. The vias penetrate the layers of the multi-layered magneto-electric dipole antenna. The probes excite magneto-electric dipoles that are provided by the horizontal patches and the vias. However, the multi-layered magneto-electric dipole antenna is manufactured using a complex process, thereby increasing the manufacturing cost of the multi-layered magneto-electric dipole antenna.

### SUMMARY

Therefore, an object of the disclosure is to provide a magneto-electric dipole antenna and an antenna array using the same. The magneto-electric dipole antenna can be manufactured using a simple process.

According to an aspect of the disclosure, the magneto-electric dipole antenna includes a first substrate, a second substrate, a ground layer, a third substrate, four sector patches, four ground plates, four vias, a first feed-in line, a second feed-in line, a first feed-out line, a second feed-out line, a first feed-out probe and a second feed-out probe. The first substrate, the second substrate, the ground layer and the third substrate are stacked from top to bottom. The sector patches are disposed on an upper surface of the first substrate. The ground plates are disposed on a lower surface of the third substrate. Each of the vias extends from top to bottom, and penetrates the second substrate, the ground layer and the third substrate. The first feed-in line and the second feed-in line are disposed on the lower surface of the third substrate. The first feed-out line is disposed on the upper surface of the first substrate. The second feed-out line is disposed on an upper surface of the second substrate. Each of the first feed-out probe and the second feed-out probe extends from top to bottom, and penetrates the first substrate, the second substrate, the ground layer and the third substrate. The first feed-out probe is connected to the first feed-in line and the first feed-out line. The second feed-out probe is connected to the second feed-in line and the second feed-out line. When two signals are respectively fed to the first feed-in line and the second feed-in line, the signals are transmitted respectively to the first feed-out line and the second feed-out line respectively through the first feed-out probe and the second feed-out probe, and two electromagnetic waves are radiated.

According to another aspect of the disclosure, the antenna array includes a first antenna, a second antenna, a third antenna and a fourth antenna, each of which is the magneto-electric dipole antenna described above. The fourth antenna is aligned with the first antenna in a first direction, and has mirror symmetry with the first antenna with respect to a first plane perpendicular to the first direction. The second antenna is aligned with the first antenna in a second direction, and has mirror symmetry with the first antenna with respect to a second plane perpendicular to the second direction. The third antenna is aligned with the fourth antenna in the second direction, and has mirror symmetry with the fourth antenna with respect to the second plane.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view of a first embodiment of a magneto-electric dipole antenna according to the disclosure.

FIG. 2 is an exploded perspective view of the first embodiment of the magneto-electric dipole antenna.

FIG. 3 is a top view of the first embodiment of the magneto-electric dipole antenna.

FIG. 4 is a sectional view of the first embodiment of the magneto-electric dipole antenna taken along line IV-IV of FIG. 3.

FIG. 5 is a plot illustrating various scattering parameters of the first embodiment of the magneto-electric dipole antenna.

FIG. 6 is a plot illustrating radiation patterns of the first embodiment of the magneto-electric dipole antenna on various planes.

FIG. 7 is a top view of a first embodiment of an antenna array according to the disclosure.

FIGS. 8 and 9 are plots illustrating various scattering parameters of the first embodiment of the antenna array.

FIG. 10 is a plot illustrating radiation patterns of the first embodiment of the antenna array on various planes.

FIG. 11 is a perspective view of a second embodiment of the magneto-electric dipole antenna according to the disclosure.

FIG. 12 is a top view of the second embodiment of the magneto-electric dipole antenna.

FIG. 13 is a plot illustrating various scattering parameters of the second embodiment of the magneto-electric dipole antenna.

FIG. 14 is a plot illustrating radiation patterns of the second embodiment of the magneto-electric dipole antenna on various planes.

FIG. 15 is a top view of a second embodiment of the antenna array according to the disclosure.

FIGS. 16 and 17 are plots illustrating various scattering parameters of the second embodiment of the antenna array.

FIG. 18 is a plot illustrating radiation patterns of the second embodiment of the antenna array on various planes.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

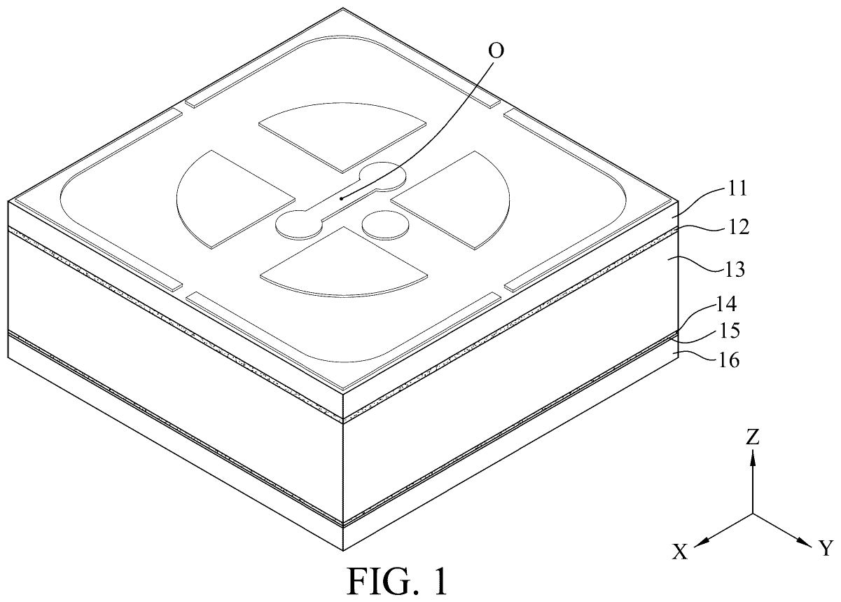

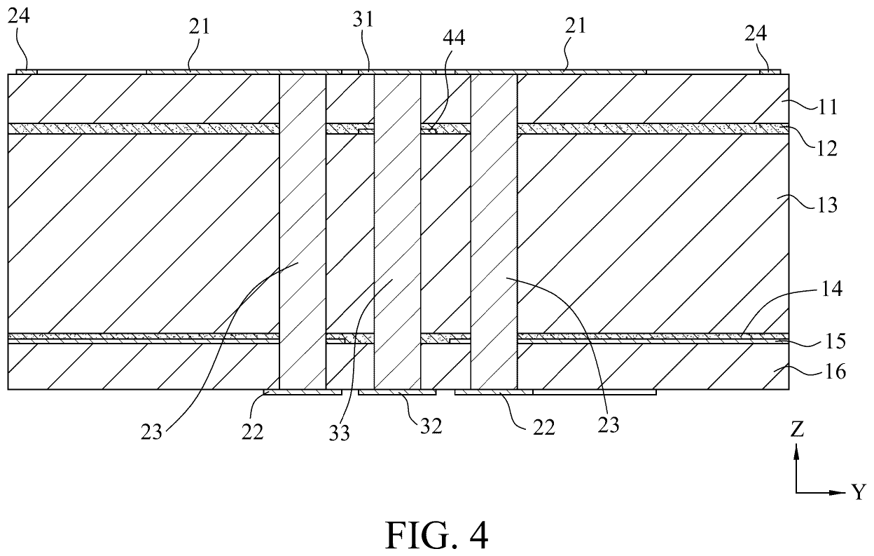

Referring to FIGS. 1 to 4, a first embodiment of a magneto-electric dipole antenna according to the disclosure includes a first substrate 11, a first adhesive layer 12, a second substrate 13, a second adhesive layer 14, a ground layer 15, a third substrate 16, four sector patches 21, four ground plates 22, four vias 23, four parasitic resonators 24, a first feed-out line 31, a second feed-out line 41, a first feed-in line 32, a second feed-in line 42, a first feed-out probe 33, a second feed-out probe 43, a feed-out plate 34 and a feed-out ring 44. The first substrate 11, the first adhesive layer 12, the second substrate 13, the second adhesive layer 14, the ground layer 15 and the third substrate 16 are stacked from top to bottom in the given order (i.e., being stacked in the given order along a direction that is reverse to a Z-direction pointing from bottom to top). Each of the first substrate 11, the first adhesive layer 12, the second substrate 13, the second adhesive layer 14 and the third substrate 16 is made of a dielectric material. The ground layer 15 is made of metal.

The sector patches 21 are made of metal, are disposed on an upper surface of the first substrate 11, and are arranged annularly around a center (O) of the upper surface of the first substrate 11. Each of the sector patches 21 has an apex 211 that is close to the center (O) of the upper surface of the first substrate 11, and an arc 212 that is distal from the center (O) of the upper surface of the first substrate 11. The sector patches 21 are spaced apart from each other, and include a first sector patch (21a), a second sector patch (21b), a third sector patch (21c) and a fourth sector patch (21d). The second sector patch (21b) is aligned with the first sector patch (21a) in an X-direction (also referred to as a first direction) that is, for example, perpendicular to the Z-direction, and is offset from the first sector patch (21a) in a counterclockwise orientation by 90 degrees. The third sector patch (21c) is aligned with the second sector patch (21b) in a Y-direction (also referred to as a second direction) that is, for example, perpendicular to the Z-direction and the X-direction, and is offset from the second sector patch (21b) in a counterclockwise orientation by 90 degrees. The fourth sector patch (21d) is aligned with the third sector patch (21c) in the X-direction, and is offset from the third sector patch (21c) in a counterclockwise orientation by 90 degrees. Any two adjacent ones of the sector patches 21 are separated by a corresponding space 201. Each of the sector patches 21 serves as an electric dipole.

Each of the ground plates 22 is made of metal, and has, for example, a circular shape. The ground plates 22 are disposed on a lower surface of the third substrate 16 and respectively in projections of the sector patches 21 on the lower surface of the third substrate 16.

Each of the vias 23 is made of metal, and has, for example, a cylindrical shape. Each of the vias 23 extends from top to bottom, penetrates the first substrate 11, the first adhesive layer 12, the second substrate 13, the second adhesive layer 14, the ground layer 15 and the third substrate 16, and is connected to a respective one of the sector patches 21 and a respective one of the ground plates 22. Each of the vias 23 serves as a magnetic dipole. With respect to each of the vias 23, the magnetic dipole that is generated by the via 23 cooperates with the electric dipole that is generated by the sector patch 21 connected to the via 23 to form a magneto-electric dipole.

Each of the parasitic resonators 24 is made of metal, and has, for example, an L shape. The parasitic resonators 24 are disposed on the upper surface of the first substrate 11, are arranged annularly around the center (O), and cooperatively enclose the sector patches 21. Each of the parasitic resonators 24 is spaced apart from a respective one of the sector patches 21 by a space 202, and has a first edge 241 that is close to the respective one of the sector patches 21 and a second edge 242 that is distal from the respective one of the sector patches 21. With respect to each of the parasitic resonators 24, a center of the second edge 242 of the parasitic resonator 24, a center of the first edge 241 of the parasitic resonator 24 and the apex 211 of the respective one of the sector patches 21 are located on a straight line.

The first feed-out line 31 is made of metal, is disposed on the upper surface of the first substrate 11, extends along the X-direction, and is spaced apart from the sector patches 21. The first feed-out line 31 has a first end portion 311, a second end portion 312, and a center that coincides with the center (O) of the upper surface of the first substrate 11. The second feed-out line 41 is made of metal, is disposed on an upper surface of the second substrate 13, extends along the Y-direction, and is spaced apart from projections of the sector patches 21 on the upper surface of the second substrate 13. The second feed-out line 41 has a first end portion 411, a second end portion 412, and a center that coincides with a projection of the center of the first feed-out line 31 on the second feed-out line 41.

The first feed-in line 32 and the second feed-in line 42 are made of metal, and are disposed on the lower surface of the third substrate 16. The first feed-in line 32 extends in the X-direction, and has an end portion that overlaps a projection of the second end portion 312 of the first feed-out line 31 on the lower surface of the third substrate 16. The second feed-in line 42 extends in the Y-direction, and has an end portion that overlaps a projection of the second end portion 412 of the second feed-out line 41 on the lower surface of the third substrate 16.

Each of the first feed-out probe 33 and the second feed-out probe 43 is made of metal, and has, for example, a cylindrical shape. Each of the first feed-out probe 33 and the second feed-out probe 43 extends from top to bottom, and penetrates the first substrate 11, the first adhesive layer 12, the second substrate 13, the second adhesive layer 14, the ground layer 15 and the third substrate 16. The first feed-out probe 33 is connected to the second end portion 312 of the first feed-out line 31 and the end portion of the first feed-in line 32. The second feed-out probe 43 is connected to the second end portion 412 of the second feed-out line 41 and the end portion of the second feed-in line 42. The ground layer 15 is spaced apart from the first feed-out probe 33 and the second feed-out probe 43.

The feed-out plate 34 is made of metal, and has, for example, a circular shape. The feed-out plate 34 is disposed on the upper surface of the first substrate 11, is spaced apart from the sector patches 21, is aligned with the first feed-out line 31 in the Y-direction, and is connected to the second feed-out probe 43. The feed-out ring 44 is made of metal, and has, for example, a circular shape. The feed-out ring 44 is disposed on the upper surface of the second substrate 13, is spaced apart from the projections of the sector patches 21 on the upper surface of the second substrate 13, is aligned with the second feed-out line 41 in the X-direction, and surrounds and is connected to the first feed-out probe 33.

When two signals are respectively fed to the first feed-in line 32 and the second feed-in line 42, the signal fed to the first feed-in line 32 is transmitted to the first feed-out line 31 through the first feed-out probe 33, so as to excite the magneto-electric dipoles to achieve horizontal polarization and radiate an electromagnetic wave along the X-direction, and the signal fed to the second feed-in line 42 is transmitted to the second feed-out line 41 through the second feed-out probe 43, so as to excite the magneto-electric dipoles to achieve vertical polarization and radiate an electromagnetic wave along the Y-direction.

In this embodiment, the magneto-electric dipole antenna is configured to operate in a Ka-band of from 27 GHz to 31 GHZ, and can be used in a low-orbit satellite system.

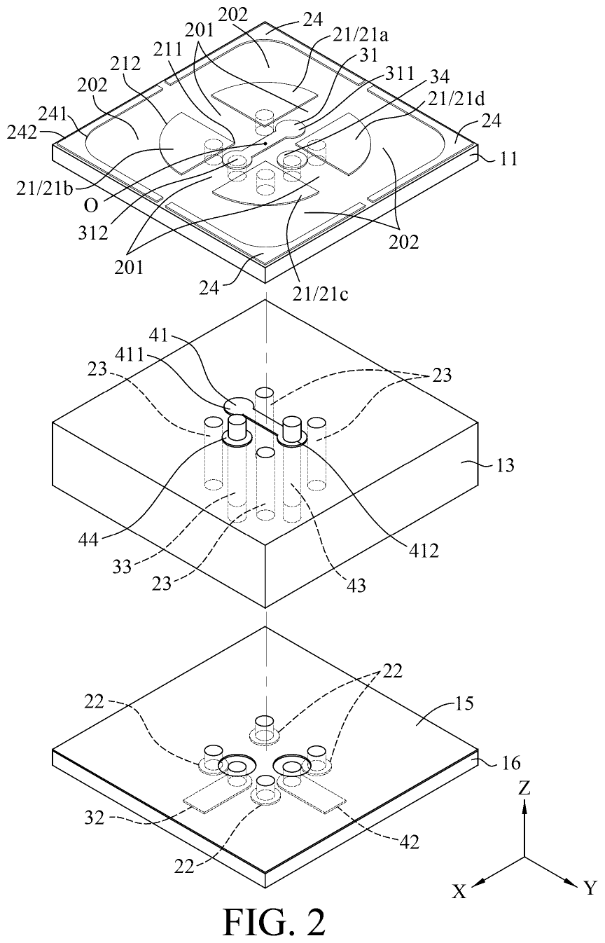

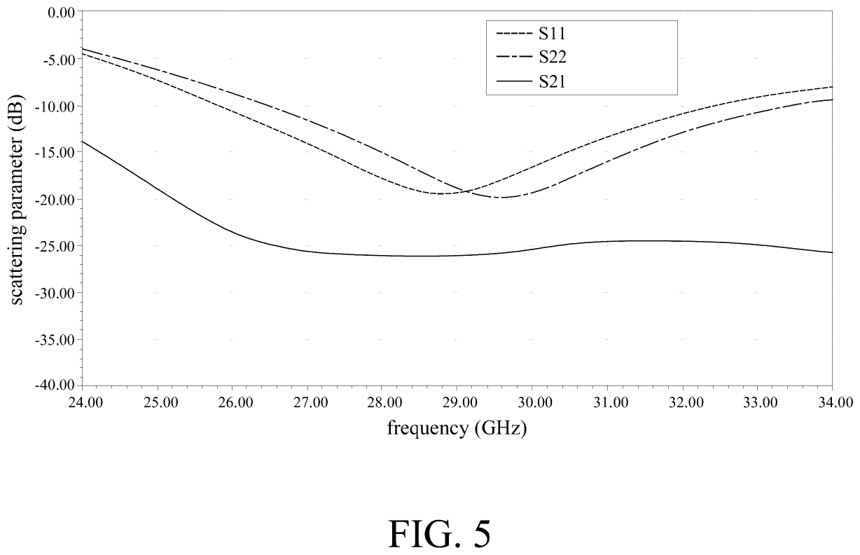

FIG. 5 is a plot illustrating scattering parameters (S11, S22, S21) of the magneto-electric dipole antenna of this embodiment in a frequency range of from 24 GHz to 34 GHz. Referring to FIGS. 2 and 5, the scattering parameter (S11) is a reflection coefficient at the first feed-in line 32, and is smaller than a target value (e.g., −10 dB) of the scattering parameter (S11) in the Ka-band of from 27 GHz to 31 GHz. The scattering parameter (S22) is a reflection coefficient at the second feed-in line 42, and is smaller than a target value (e.g., −10 dB) of the scattering parameter (S22) in the Ka-band of from 27 GHz to 31 GHz. The scattering parameter (S21) is related to isolation between the first feed-in line 32 and the second feed-in line 42, and is smaller than a target value (e.g., −20 dB) of the scattering parameter (S21) in the Ka-band of from 27 GHz to 31 GHz.

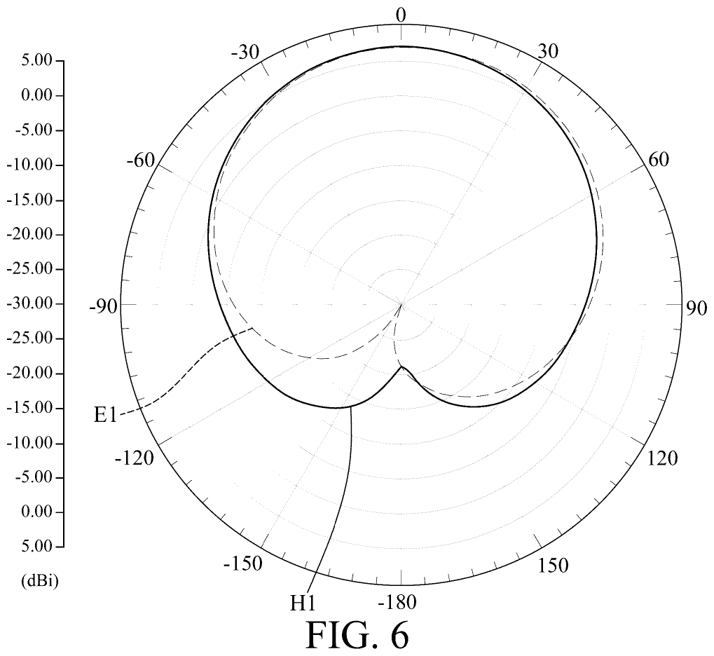

FIG. 6 is a plot illustrating radiation patterns (E1, H1) of the magneto-electric dipole antenna of this embodiment at a center frequency of the Ka-band (i.e., 29 GHZ). The radiation pattern (E1) is obtained on an E-plane. The radiation pattern (H1) is obtained on an H-plane. It can be reasonably determined from FIG. 6 that the magneto-electric dipole antenna of this embodiment has a gain of 6.96 dBi.

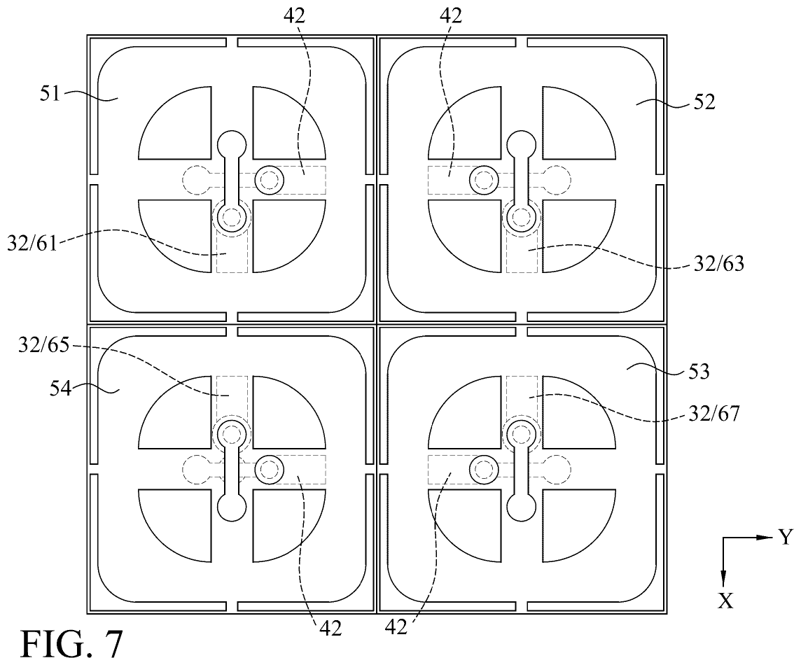

Referring to FIG. 7, a first embodiment of an antenna array according to the disclosure includes a first antenna 51, a second antenna 52, a third antenna 53 and a fourth antenna 54, each of which is the magneto-electric dipole antenna described above. The fourth antenna 54 is aligned with the first antenna 51 in the X-direction, and has mirror symmetry with the first antenna 51 with respect to a first plane perpendicular to the X-direction. The second antenna 52 is aligned with the first antenna 51 in the Y-direction, and has mirror symmetry with the first antenna 51 with respect to a second plane perpendicular to the Y-direction. The third antenna 53 is aligned with the fourth antenna 54 in the Y-direction, and has mirror symmetry with the fourth antenna 54 with respect to the second plane.

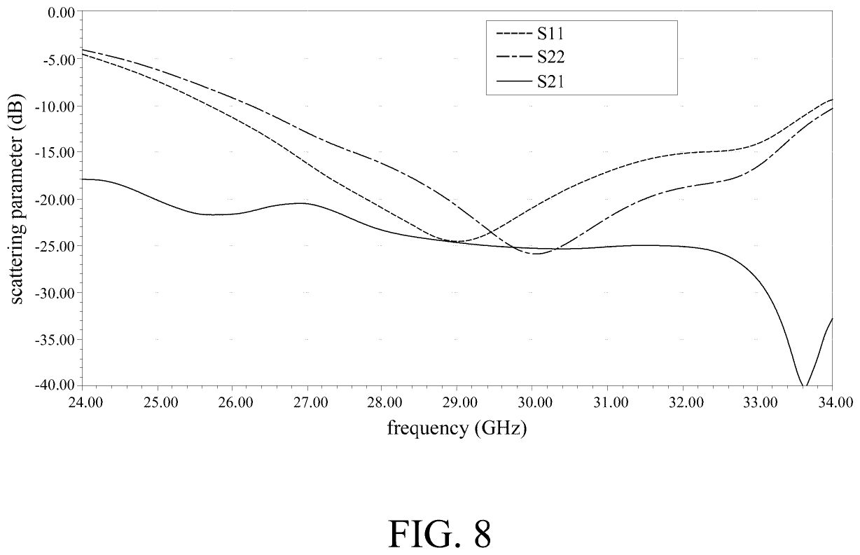

FIG. 8 is a plot illustrating scattering parameters (S11, S22, S21) of the first antenna 51 in a frequency range of from 24 GHz to 34 GHz. Referring to FIGS. 7 and 8, the scattering parameter (S11) is a reflection coefficient at the first feed-in line 32 of the first antenna 51, and is smaller than a target value (e.g., −10 dB) of the scattering parameter (S11) in the Ka-band of from 27 GHz to 31 GHz. The scattering parameter (S22) is a reflection coefficient at the second feed-in line 42 of the first antenna 51, and is smaller than a target value (e.g., −10 dB) of the scattering parameter (S22) in the Ka-band of from 27 GHz to 31 GHz. The scattering parameter (S21) is related to isolation between the first feed-in line 32 and the second feed-in line 42 of the first antenna 51, and is smaller than a target value (e.g., −20 dB) of the scattering parameter (S21) in the Ka-band of from 27 GHz to 31 GHz.

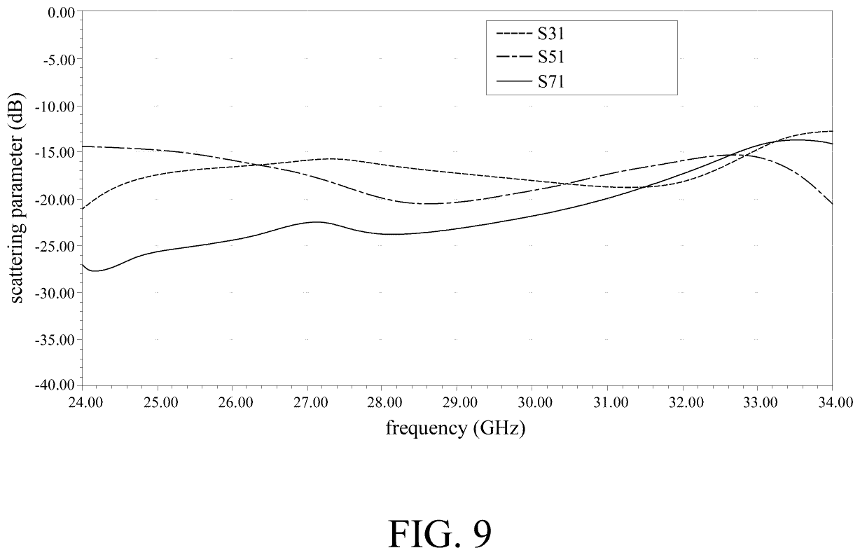

FIG. 9 is a plot illustrating scattering parameters (S31, S51, S71) of the antenna array of this embodiment in a frequency range of from 24 GHz to 34 GHz. Referring to FIGS. 7 and 9, the scattering parameter (S31) is related to isolation between the first feed-in line 32 of the first antenna 51 (serving as a first port 61 of the antenna array) and the first feed-in line 32 of the second antenna 52 (serving as a third port 63 of the antenna array), and is smaller than a target value (e.g., −15 dB) of the scattering parameter (S31) in the Ka-band of from 27 GHz to 31 GHz. The scattering parameter (S51) is related to isolation between the first feed-in line 32 of the first antenna 51 (i.e., the first port 61 of the antenna array) and the first feed-in line 32 of the fourth antenna 54 (serving as a fifth port 65 of the antenna array), and is smaller than a target value (e.g., −15 dB) of the scattering parameter (S51) in the Ka-band of from 27 GHz to 31 GHz. the scattering parameter (S71) is related to isolation between the first feed-in line 32 of the first antenna 51 (i.e., the first port 61 of the antenna array) and the first feed-in line 32 of the third antenna 53 (serving as a seventh port 67 of the antenna array), and is smaller than a target value (e.g., −15 dB) of the scattering parameter (S71) in the Ka-band of from 27 GHz to 31 GHz.

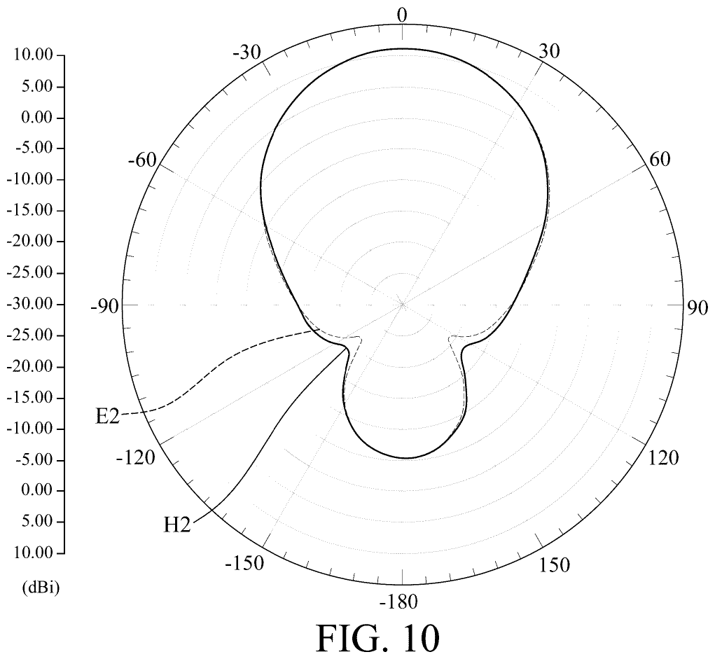

FIG. 10 is a plot illustrating radiation patterns (E2, H2) of the antenna array of this embodiment at the center frequency of the Ka-band (i.e., 29 GHz). The radiation pattern (E2) is obtained on an E-plane. The radiation pattern (H2) is obtained on an H-plane. It can be reasonably determined from FIG. 10 that the antenna array of this embodiment has a gain of 10.92 dBi.

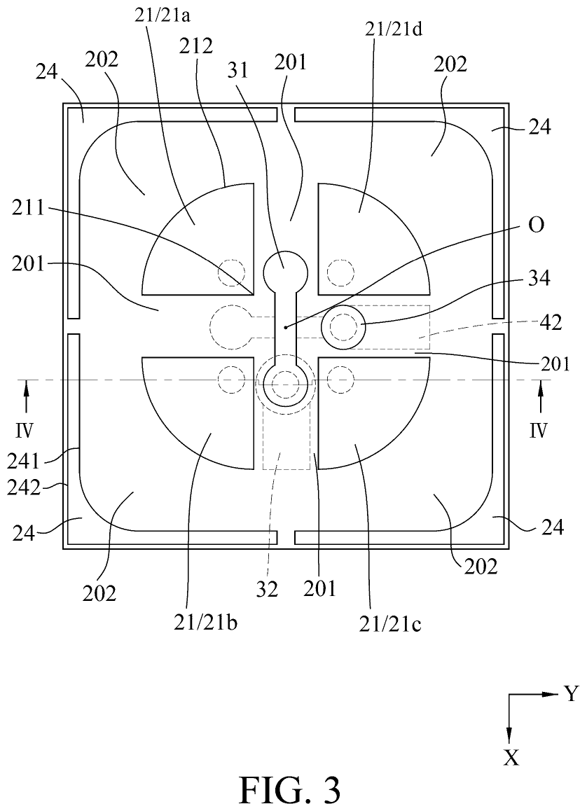

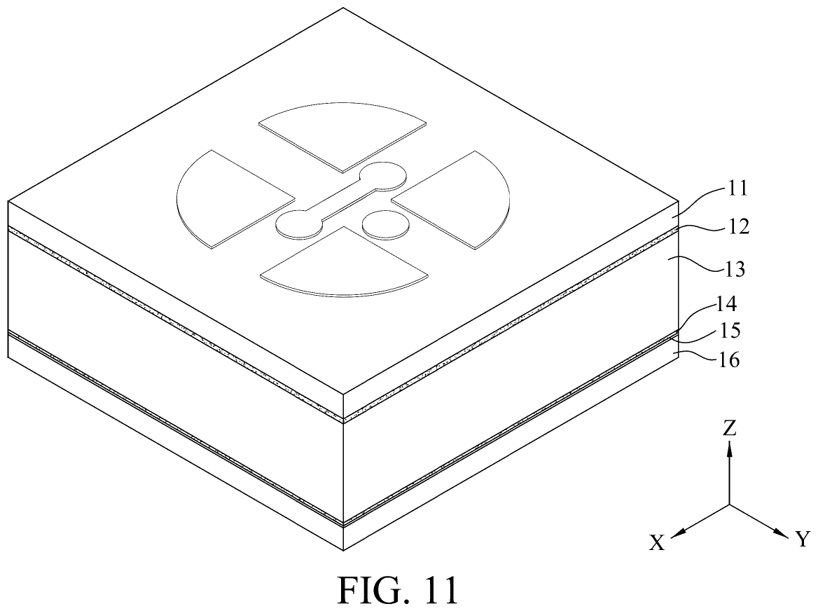

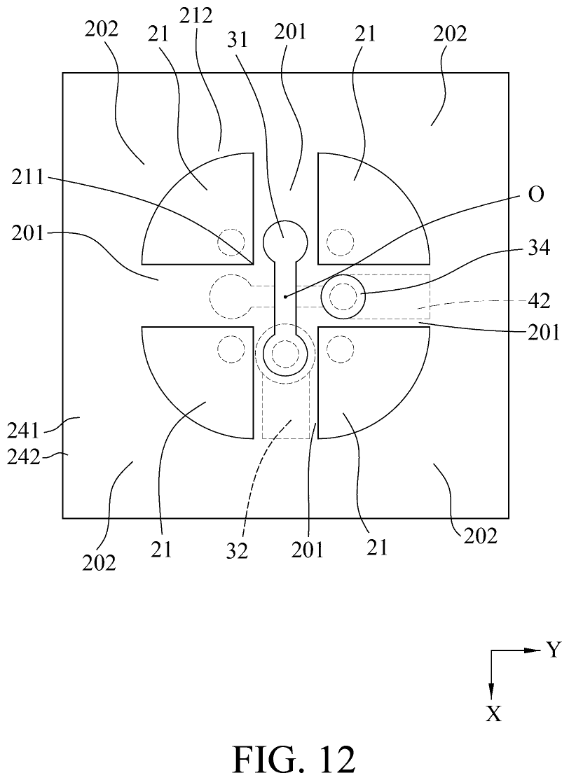

Referring to FIGS. 11 and 12, a second embodiment of the magneto-electric dipole antenna according to the disclosure is similar to the first embodiment of the magneto-electric dipole antenna depicted in FIGS. 1 to 4, but differs from the first embodiment in that the parasitic resonators 24 (see FIG. 3) are omitted in the second embodiment. It should be noted that, in other embodiments of the magneto-electric dipole antenna, the feed-out plate 34 (see FIG. 2) and the feed-out ring 44 (see FIG. 2) may be omitted.

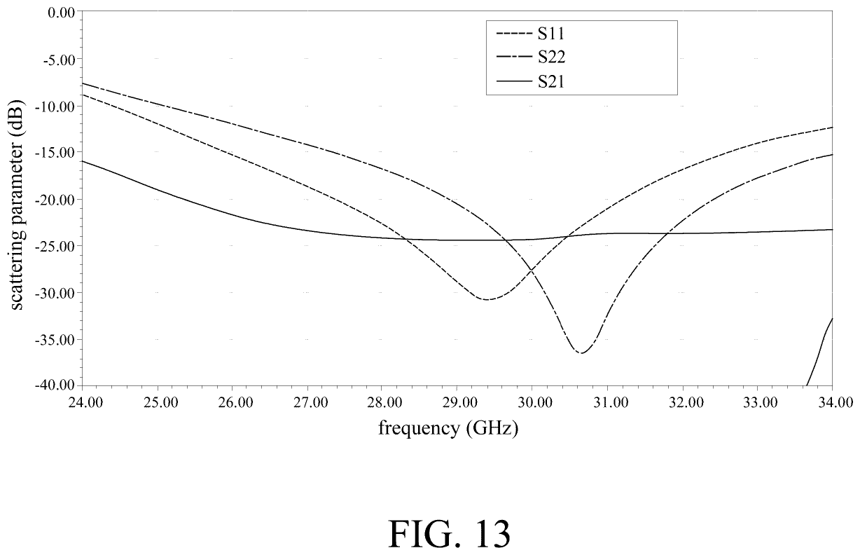

FIG. 13 is a plot illustrating scattering parameters (S11, S22, S21) of the magneto-electric dipole antenna of the second embodiment in a frequency range of from 24 GHz to 34 GHz. Referring to FIGS. 12 and 13, the scattering parameter (S11) is a reflection coefficient at the first feed-in line 32, and is smaller than a target value (e.g., −10 dB) of the scattering parameter (S11) in the Ka-band of from 27 GHz to 31 GHz. The scattering parameter (S22) is a reflection coefficient at the second feed-in line 42, and is smaller than a target value (e.g., −10 dB) of the scattering parameter (S22) in the Ka-band of from 27 GHz to 31 GHz. The scattering parameter (S21) is related to isolation between the first feed-in line 32 and the second feed-in line 42, and is smaller than a target value (e.g., −20 dB) of the scattering parameter (S21) in the Ka-band of from 27 GHz to 31 GHz.

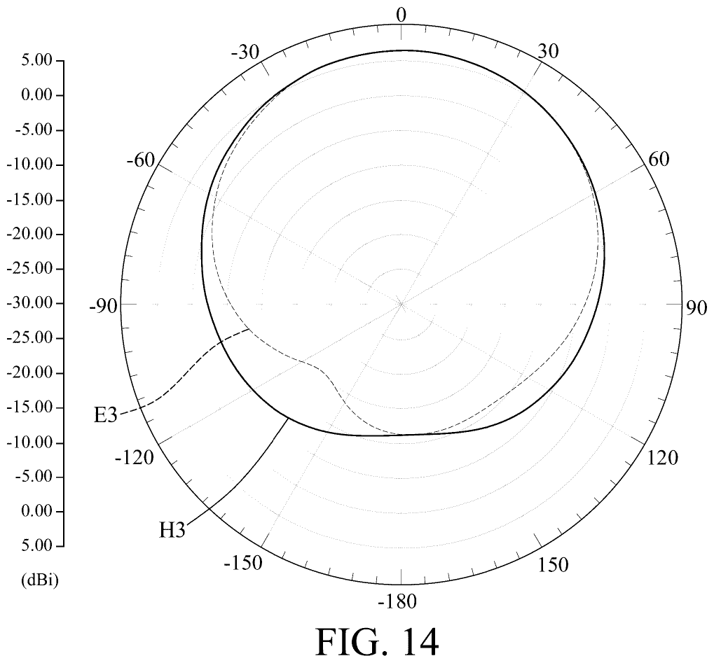

FIG. 14 is a plot illustrating radiation patterns (E3, H3) of the magneto-electric dipole antenna of the second embodiment at the center frequency of the Ka-band (i.e., 29 GHZ). The radiation pattern (E3) is obtained on an E-plane. The radiation pattern (H3) is obtained on an H-plane. It can be reasonably determined from FIG. 14 that the magneto-electric dipole antenna of the second embodiment has a gain of 6.20 dBi.

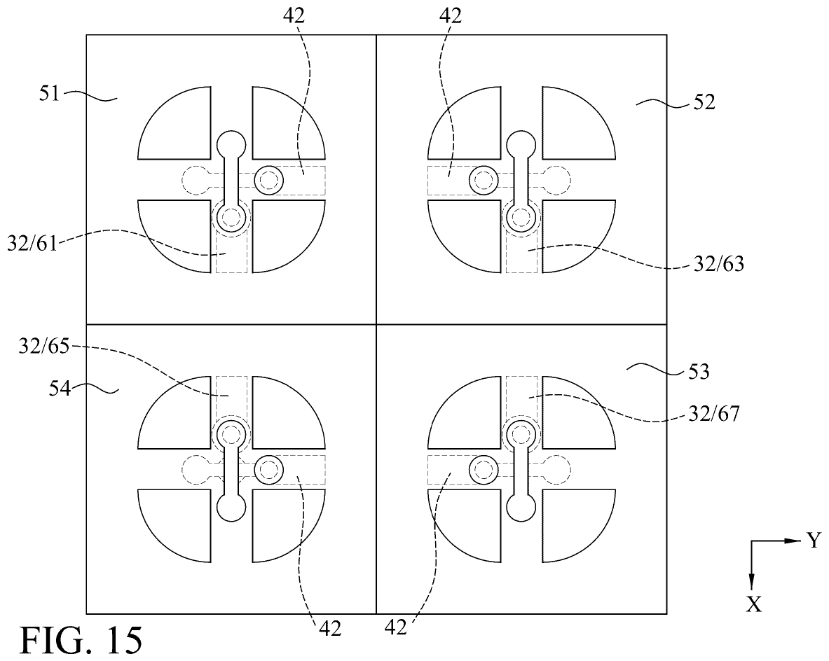

Referring to FIG. 15, a second embodiment of the antenna array according to the disclosure is similar to the first embodiment of the antenna array depicted in FIG. 7, but differs from the first embodiment of the antenna array in that each of the first antenna 51, the second antenna 52, the third antenna 53 and the fourth antenna 54 is the magneto-electric dipole antenna of the second embodiment depicted in FIGS. 11 and 12.

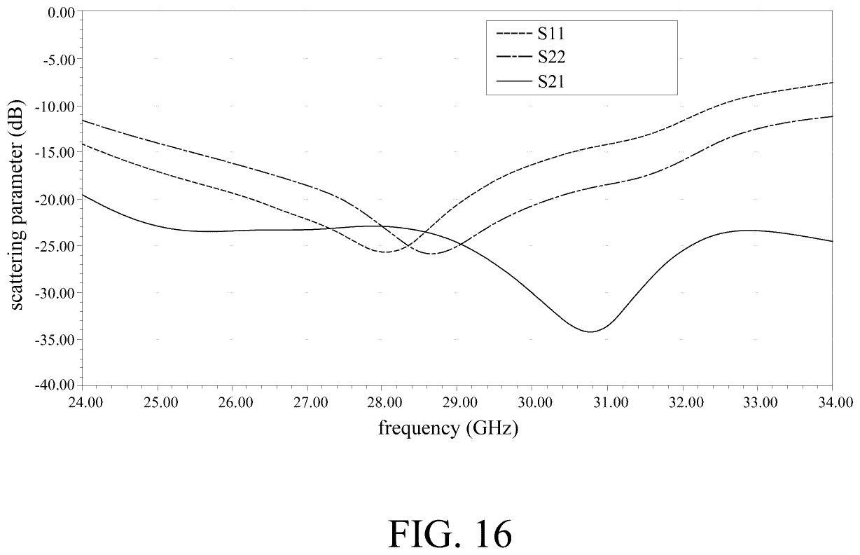

FIG. 16 is a plot illustrating scattering parameters (S11, S22, S21) of the first antenna 51 in a frequency range of from 24 GHz to 34 GHz. Referring to FIGS. 15 and 16, the scattering parameter (S11) is a reflection coefficient at the first feed-in line 32 of the first antenna 51, and is smaller than a target value (e.g., −10 dB) of the scattering parameter (S11) in the Ka-band of from 27 GHz to 31 GHz. The scattering parameter (S22) is a reflection coefficient at the second feed-in line 42 of the first antenna 51, and is smaller than a target value (e.g., −10 dB) of the scattering parameter (S22) in the Ka-band of from 27 GHz to 31 GHz. The scattering parameter (S21) is related to isolation between the first feed-in line 32 and the second feed-in line 42 of the first antenna 51, and is smaller than a target value (e.g., −20 dB) of the scattering parameter (S21) in the Ka-band of from 27 GHz to 31 GHz.

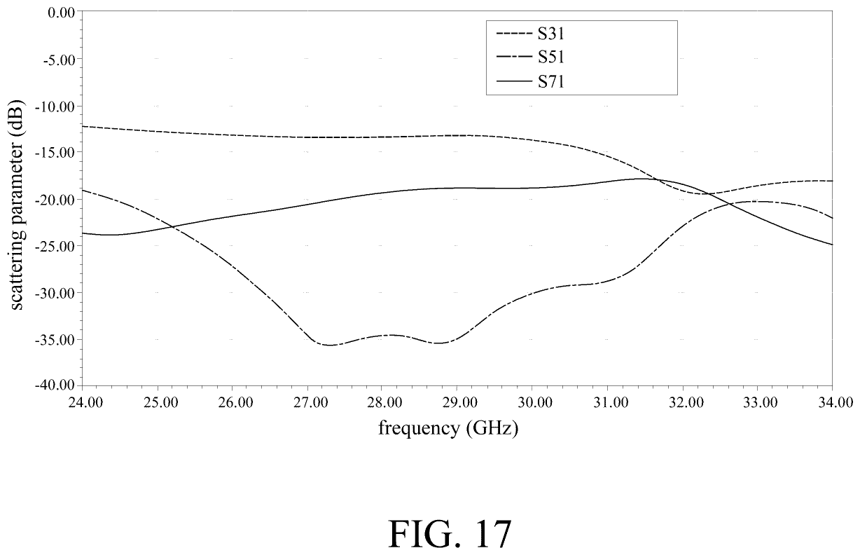

FIG. 17 is a plot illustrating scattering parameters (S31, S51, S71) of the antenna array of the second embodiment in a frequency range of from 24 GHz to 34 GHz. Referring to FIGS. 15 and 17, the scattering parameter (S31) is related to isolation between the first feed-in line 32 of the first antenna 51 (i.e., the first port 61 of the antenna array) and the first feed-in line 32 of the second antenna 52 (i.e., the third port 63 of the antenna array), and is smaller than a target value (e.g., −10 dB) of the scattering parameter (S31) in the Ka-band of from 27 GHz to 31 GHz. The scattering parameter (S51) is related to isolation between the first feed-in line 32 of the first antenna 51 (i.e., the first port 61 of the antenna array) and the first feed-in line 32 of the fourth antenna 54 (i.e., the fifth port 65 of the antenna array), and is smaller than a target value (e.g., −10 dB) of the scattering parameter (S51) in the Ka-band of from 27 GHz to 31 GHz. the scattering parameter (S71) is related to isolation between the first feed-in line 32 of the first antenna 51 (i.e., the first port 61 of the antenna array) and the first feed-in line 32 of the third antenna 53 (i.e., the seventh port 67 of the antenna array), and is smaller than a target value (e.g., −10 dB) of the scattering parameter (S71) in the Ka-band of from 27 GHz to 31 GHz.

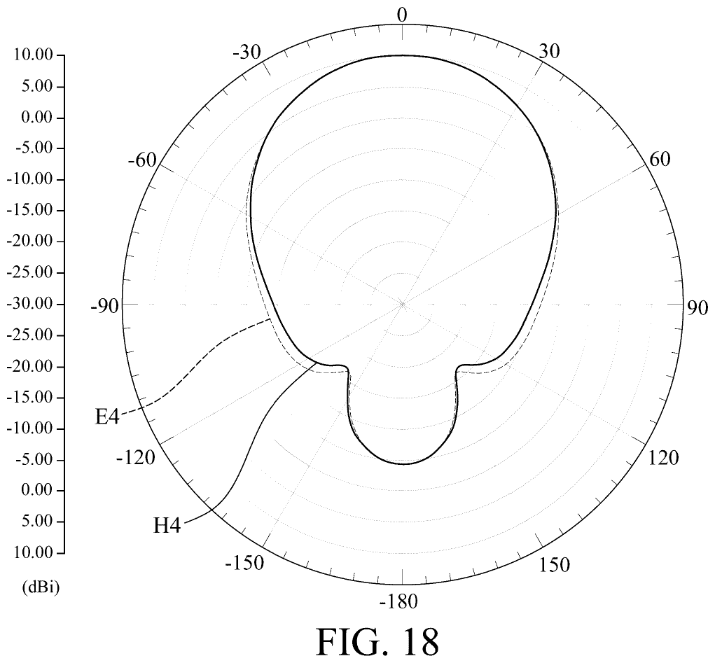

FIG. 18 is a plot illustrating radiation patterns (E4, H4) of the antenna array of the second embodiment at the center frequency of the Ka-band (i.e., 29 GHZ). The radiation pattern (E4) is obtained on an E-plane. The radiation pattern (H4) is obtained on an H-plane. It can be reasonably determined from FIG. 18 that the antenna array of the second embodiment has a gain of 10.06 dBi.

Referring to FIGS. 3 and 12, in view of the above, for each of the embodiments of the magneto-electric dipole antenna, since all of the patches of the magneto-electric dipole antenna (i.e., the four sector patches 21) are disposed on the same plane, the magneto-electric dipole antenna can to be manufactured using a simple process, thereby decreasing the manufacturing cost of the magneto-electric dipole antenna.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A magneto-electric dipole antenna comprising:
a first substrate, a second substrate, a ground layer and a third substrate that are stacked from top to bottom;
four sector patches disposed on an upper surface of said first substrate;
four ground plates disposed on a lower surface of said third substrate;
four vias, each of which extends from top to bottom and penetrates said second substrate, said ground layer and said third substrate;
a first feed-in line and a second feed-in line that are disposed on said lower surface of said third substrate;
a first feed-out line disposed on said upper surface of said first substrate;
a second feed-out line disposed on an upper surface of said second substrate; and
a first feed-out probe and a second feed-out probe, each of which extends from top to bottom and penetrates said first substrate, said second substrate, said ground layer and said third substrate, said first feed-out probe being connected to said first feed-in line and said first feed-out line, said second feed-out probe being connected to said second feed-in line and said second feed-out line;
wherein, when two signals are respectively fed to said first feed-in line and said second feed-in line, the signals are transmitted respectively to said first feed-out line and said second feed-out line respectively through said first feed-out probe and said second feed-out probe, and two electromagnetic waves are radiated.

2. The magneto-electric dipole antenna as claimed in claim 1, wherein:
said sector patches are spaced apart from each other, and includes a first sector patch, a second sector patch, a third sector patch and a fourth sector patch;
said second sector patch is aligned with said first sector patch in a first direction, and is offset from said first sector patch in a counterclockwise orientation by 90 degrees;
said third sector patch is aligned with said second sector patch in a second direction, and is offset from said second sector patch in a counterclockwise orientation by 90 degrees; and
said fourth sector patch is aligned with said third sector patch in the first direction, and is offset from said third sector patch in a counterclockwise orientation by 90 degrees.

3. The magneto-electric dipole antenna as claimed in claim 1, further comprising four parasitic resonators that are disposed on said upper surface of said first substrate and that are respectively spaced apart from said sector patches.

4. The magneto-electric dipole antenna as claimed in claim 3, wherein said parasitic resonators each have an L shape, and cooperatively enclose said sector patches.

5. The magneto-electric dipole antenna as claimed in claim 3, wherein said parasitic resonators are made of metal.

6. The magneto-electric dipole antenna as claimed in claim 1, further comprising:
a feed-out plate disposed on said upper surface of said first substrate, and connected to said second feed-out probe; and
a feed-out ring disposed on said upper surface of said second substrate, and connected to said first feed-out probe.

7. The magneto-electric dipole antenna as claimed in claim 6, wherein said feed-out plate and said feed-out ring are made of metal.

8. The magneto-electric dipole antenna as claimed in claim 6, wherein:
a projection of a center of said first feed-out line on said second feed-out line coincides with a center of said second feed-out line;
said first feed-out line extends in a first direction, and is aligned with said feed-out plate in a second direction;
said first feed-out probe is connected to an end portion of said first feed-out line;
said second feed-out line extends in the second direction, and is aligned with said feed-out ring in the first direction; and
said second feed-out probe is connected to an end portion of said second feed-out line.

9. The magneto-electric dipole antenna as claimed in claim 1, wherein said first substrate, said second substrate and said third substrate are made of a dielectric material.

10. The magneto-electric dipole antenna as claimed in claim 1, wherein said ground layer, said sector patches, said ground plates, said first feed-out line, said first feed-in line, said first feed-out probe, said second feed-out line, said second feed-in line and said first feed-out probe are made of metal.

11. An antenna array comprising:
a first antenna, a second antenna, a third antenna and a fourth antenna, each of which is a magneto-electric dipole antenna according to claim 1;
wherein said fourth antenna is aligned with said first antenna in a first direction, and has mirror symmetry with said first antenna with respect to a first plane perpendicular to the first direction;
wherein said second antenna is aligned with said first antenna in a second direction, and has mirror symmetry with said first antenna with respect to a second plane perpendicular to the second direction; and
wherein said third antenna is aligned with said fourth antenna in the second direction, and has mirror symmetry with said fourth antenna with respect to the second plane.
